(19) United States
(12) Patent Application Publication
(10) Pub. No.: US 2023/0357055 A1
(43) Pub. Date: Nov. 9, 2023

(54) METHODS FOR REMOVING DEICING SALT IONS FROM WATER RUNOFF

(71) Applicant: VIRGINIA TECH INTELLECTUAL PROPERTIES, INC., Blacksburg, VA (US)

(72) Inventors: Gregory E. Welbaum, Blacksburg, VA (US); Austin Dylan King, Grants Pass, OR (US)

(21) Appl. No.: 18/313,523

(22) Filed: May 8, 2023

Related U.S. Application Data
(60) Provisional application No. 63/364,384, filed on May 9, 2022.

(51) Int. Cl. C02F 1/28

(52) U.S. Cl. CPC C02F 1/286; C02F 1/285; C02F 1/281; C02F 2103/001

(57) ABSTRACT

In accordance with the purpose(s) of the present disclosure, as embodied and broadly described herein, the disclosure, in one aspect, relates to methods for removing deicing salt ions from water. In one aspect, the method involves contacting the water with deicing salt ions with a device comprising an ionic binding material present in a porous housing. Additionally, described herein are methods for recharging the device so that the device can be re-used multiple times.

### CROSS-REFERENCE TO RELATED APPLICATIONS

This application claims the benefit of and priority to co-pending U.S. Provisional Patent Application No. 63/364,384, filed on May 9, 2022, the contents of which are incorporated by reference herein in their entireties.

### BACKGROUND

More than 23 million tons of salt (primarily sodium chloride or sometimes magnesium, potassium, or calcium chloride) are applied to roadways and parking lots annually in the US. This salt is ultimately washed/blown from the pavement into the surrounding environments including waterways and aquifers, negatively impacting water supplies, soils, crops, and wildlife. Salt accumulation can kill wildlife in freshwater ecosystems, because high chloride levels are toxic to fish, insects, and amphibians, according to the Environmental Protection Agency. Salt is also corrosive. Not only does salt rust vehicles it also corrodes roads, bridges, and other infrastructure. Damage from salt corrosion alone may cost the U.S. as much as $5 billion a year. Drinking water supplies with excessive levels of salt constituents such as sodium and chloride may require additional and expensive treatment beyond conventional methods to remove these dissolved contaminates that may adversely impact taste and user health. Because of these negative factors, the environmental sustainability of roadway deicing salts has been questioned. Technologies are needed to capture roadway deicing salts before they enter ecosystems surrounding paved areas to mitigate their negative effects on the environment.

### SUMMARY

In accordance with the purpose(s) of the present disclosure, as embodied and broadly described herein, the disclosure, in one aspect, relates to methods for removing deicing salt ions from water. In one aspect, the method involves contacting the water with deicing salt ions with a device comprising an ionic binding material present in a porous housing. Additionally, described herein are methods for recharging the device so that the device can be re-used multiple times.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows an exemplary device described herein.

FIG. 2 shows the results of different materials for removing sodium and chloride ion (values are expressed in mg/kg on a dry-weight basis).

FIG. 3 shows the comparison of ECS biofillers ability to bind to sodium and chloride particles. Panels A & B show the results from both groups for Na⁺ and Cl⁻, respectively. “Control” indicates ion content from ECS not exposed to NaCl and corresponds with the “a” on both panels, whereas “Treatment” indicates ion content from ECS exposed to NaCl and corresponds with the “b” on both panels. The colored dots correspond to the results from a specific biofiller treatment. The box around dots represents the average variation amongst ECS treatments, as the lab took multiple samples from each section of ECS. Note that hemp hurd (sections 1&2 B) is labeled as “Hemp Biomass”, hemp bast fiber (section 1&2 C) is labeled as “Hemp Fiber”, and mix (sections 1&2 D) is labeled as “Biochar×Hemp”.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “an ion” include, but are not limited to, mixtures or combinations of two or more such ions, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range. Thus, for example, if a component is in an amount of about 1%, 2%, 3%, 4%, or 5%, where any value can be a lower and upper endpoint of a range, then any range is contemplated between 1% and 5% (e.g., 1% to 3%, 2% to 4%, etc.).

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e., one atmosphere).

### Methods for Removing Deicing Salt Ions

The use of sodium chloride rock salt (NaCl) as a deicer on roads has risen dramatically over the past century (U.S. Geological Survey, 2022). Consequently, numerous environmental and societal impacts continue to arise, such as long-term salinization of freshwater resources, corrosive damage to infrastructure, degradation of soil and aquatic ecosystems, and negative impacts to human health (Tiwari & Rachlin, 2018; Jackson & Jobbágy, 2005; Stranko et al., 2013; D'itri, 1992; Kaushal et al., 2005; Siegel, 2007; Lofgren, 2001). Despite the negative effects road salts have on our infrastructure and environment, their use is absolutely necessary because they prevent ice accumulation on roads, facilitating the function of the U.S. economy by minimizing the risk of vehicle accidents (D'itri, 1992). Although other forms of chemical deicers are utilized, NaCl is the primary compound of choice because it is affordable and readily available (D'itri, 1992; New Hampshire Department of Environmental Services, 2016).

Once salt is applied, the dissociated Na⁺ and Cl⁻ ions can infiltrate the surrounding environment through a myriad of transport mechanisms, ultimately increasing the salinity of soil, streams, lakes, wetlands, and stormwater management ponds (Jones et al., 2015; Kaushal et al., 2005). Sodium is a positively charged cation that usually attaches to the negative charged sites within the soil profile, whereas the chloride anion is much more mobile and can readily infiltrate down into groundwater supplies (New Hampshire Department of Environmental Services, 2016; D'itri, 1992; Siegel, 2007). While both elements contribute to saline runoff impacts, chloride is often the focus of studies that investigate the effects of road salt application because it is the anion of most deicing salts and stays in solution once dissociated, usually moving with water flow in a watershed. The continuous rise in chloride concentrations in freshwater resources has been linked to the use of road salt, leaving some experts to predict that current aquatic wildlife will not be able to survive in the next 50 years if this trend continues (Dugan et al., 2017).

Although there have been significant improvements in the efficiency of road salt storage and application that have lowered its entrance into the environment, additional technologies that capture and remove NaCl are required to significantly address this complex and global issue. Alternative methods such as phytoremediation of salt-affected soils and the recycling of saline runoff show tremendous potential; however, additional methods are required to more deliberately sequester NaCl runoff. The methods described herein provide a complementary sequestration strategy that would benefit areas where phytoremediation is not feasible.

In accordance with the purpose(s) of the present disclosure, as embodied and broadly described herein, the disclosure, in one aspect, relates to methods for removing deicing salt ions from water. In one aspect, the method involves contacting the water with deicing salt ions with a device comprising an ionic binding material present in a porous housing.

The devices described herein include materials that can bind and/or absorb ions produced from deicing salts. For example, ions present in deicing salts such as sodium, calcium, potassium, magnesium, and chloride can bind to the ionic binding material present in the device. Depending upon the selection of the ionic binding material, the ions can bind to the ionic binding material via electrostatic interactions, ionic binding, Van der Waals bonding, or covalent bonding. In other aspects, the devices described herein can accumulate salt by bulk saturation of liquid salt water held by the device. In this aspect, the device is behaving more a like a sponge.

In one aspect, the ionic binding material is biochar. Biochar is a porous, charcoal-like product that is produced during the oxygen-limited pyrolysis of biomass from a variety of feedstocks (Rippy et al., 2022; Zhao et al., 2019; Tan et al., 2017). Biochar can be made from basically any source of carbon, for example, from hydrocarbons (e.g., petroleum-based materials, coal, lignite, peat) and from a biomass (e.g., woods, hardwoods, softwoods, wastepaper, coconut shell, manure, chaff, food waste, etc.). Combinations and variations of these starting materials, and various and different members of each group of starting materials can be, and are, used. Thus, the large number of vastly different starting materials leads to biochars having different properties. In one aspect, the biochar is produced from green waste such as, for example, scrap wood and sawdust.

Many different pyrolysis or carbonization processes can be, and are used, to create biochars. In general, these processes involve heating the starting material under positive pressure, reduced pressure, vacuum, inert atmosphere, or flowing inert atmosphere, through one or more heating cycles where the temperature of the material is generally brought above about 400° C., and can range from about 300° C., to about 900° C. The percentage of residual carbon formed and several other initial properties are strong functions of the temperature and time history of the heating cycles. In general, the faster the heating rate and the higher the final temperature the lower the char yield, Conversely, in general, the slower the heating rate or the lower the final temperature the greater the char yield. The higher final temperatures also lead to modifying the char properties by changing the inorganic mineral matter compositions, which in turn, modify the char properties, Ramp, or heating rates, hold times, cooling profiles, pressures, flow rates, and type of atmosphere can all be controlled, and typically are different from one biochar supplier to the next. These differences potentially lead to a biochar having different properties, further framing the substantial nature of one of the problems that the present inventions address and solve. Generally, in carbonization most of the non-carbon elements, hydrogen and oxygen are first removed in gaseous form by the pyrolytic decomposition of the starting materials, e.g., the biomass. The free carbon atoms group or arrange into crystallographic formations known as elementary graphite crystallites. Typically, at this point the mutual arrangement of the crystallite is irregular, so that free interstices exist between them. Thus, pyrolysis involves thermal decomposition of carbonaceous material, e.g., the biomass, eliminating non-carbon species, and producing a fixed carbon structure capable of binding other charged molecules.

In one aspect, the ionic binding material is hemp or a component of hemp. Also known as Cannabis sativa L., hemp is a multipurpose annual plant species. Each component of the hemp plant's stalk has unique properties that allow for different applications. The inner core fibers—commonly referred to as “hurd”—are highly absorbent and can be used for animal bedding and construction materials. The contrasting bast fibers are long, sturdy, string-like in appearance and can be used to make paper and textile products (Stevulova et al., 2014; Stevulova et al., 2015). Hurd fibers represent the majority of the hemp stalk by weight (60-80%), whereas the bast fibers represent the remaining 20%-40%. The majority of bast fibers are composed of cellulose (57%-77%), with a smaller portion of hemicellulose (9%-14%) and lignin (5%-9%). Hurd fibers consist of less cellulose than bast fibers (40%-48%) and relatively more hemicellulose (18%-24%) and lignin (21%-24%) (Stevulova et al., 2014; Reh & Barbu, 2017; Nguyen et al., 2009).

The anatomical structure of hemp allows it to absorb large amounts of water—up to five times its own weight (Stevulova et al., 2014; Reh & Barbu, 2017). The high porous structure of hemp is one explanation for its absorption and adsorption capabilities (Stevulova et al., 2014; Stevulova et al., 2015; Zhao et al., 2019).

In one aspect, the ionic binding material is diatomaceous earth. Diatomaceous earth is a naturally occurring, soft, siliceous sedimentary rock that can be crumbled into a fine white to off-white powder. The typical chemical composition of oven-dried diatomaceous earth is 80-90% silica, with 2-4% alumina (attributed mostly to clay minerals), and 0.5-2% iron oxide. Diatomaceous earth consists of the fossilized remains of diatoms, a type of hard-shelled microalgae.

In another aspect, the ionic binding material are clay beads. In one aspect, calcined or sintered clay can be crushed and sieved to a particular size. The clay beads can be used alone or as composite materials, where the clay beads are formed with one or more additional materials. In one aspect, the clay beads are clay alginate beads. In another aspect, the clay beads are modified to modify the number of charged groups on the bead. For example, the clay beads can be acid treated.

In another aspect, the ionic binding material is an ion-exchange resin. Ion-exchange resins are an insoluble matrix or support structure normally in the form of small microbeads, usually white or yellowish, fabricated from an organic polymer substrate. The beads are typically porous, providing a large surface area on and inside them where the trapping of ions occurs along with the accompanying release of other ions, and thus the process is called ion exchange. In one aspect, the There are multiple types of ion-exchange resins. In one aspect, the resin is strongly acidic, typically featuring sulfonic acid groups, e.g. sodium polystyrene sulfonate or polyAMPS. In another aspect, the resin is strongly basic, typically featuring quaternary amino groups, for example, trimethylammonium groups, e.g. polyAPTAC). In another aspect, the resin is weakly acidic, typically featuring carboxylic acid groups. In another aspect, the resin is weakly basic, typically featuring primary, secondary, and/or tertiary amino groups, e.g. polyethylene amine.

In one aspect, the ionic binding material includes two or more different materials. For example, the ionic binding material comprises biochar in combination with hemp powder, hemp hurd, hemp bast fiber, or any combination thereof.

In another aspect, in addition to the ionic binding material, the devices can include one or more absorbents. The absorbents can facilitate bulk sequestration and retention of salty water. The combination of an absorbent with the ionic binding material can remove substantial amounts if deicing salt from water. In one aspect, the absorbent is vermiculite, polypropylene, cellulose, or any combination thereof. The relative amount of ionic binding material and absorbent can vary depending upon the amount of water to be treated and the concentration of ions present in the water. In one aspect, the ionic binding material and absorbent are intimately mixed with one another prior to being introduced into the porous housing.

The porous housing is any porous material that permits water to pass through the material and come into contact with the ionic binding material with optional components (e.g., absorbents). In one aspect, the porous material is a polymer such as, for example, polypropylene or polyethylene. The mesh size of the porous material can also vary as well depending upon the application of the device. The porous housing can have one or more openings that permit the introduction of the ionic binding material into the housing. After introducing the ionic binding material into the housing, the housing can be sealed so that the ionic binding material cannot escape the housing. In one aspect, the housing is tied off with a tying device so that the housing is closed. In this aspect, the tie can be removed to open the porous housing and remove the ionic binding material.

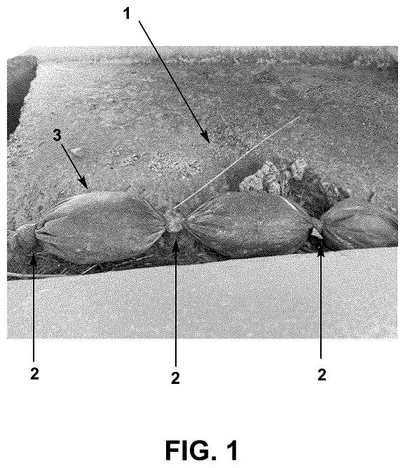

An example of this device is provided in FIG. 1. Referring to FIG. 1, the device 1 is a sock 3 (porous housing) filled with ionic binding material. The device incudes a plurality of ties 2 to ensure the ionic binding material remains in the porous housing. The number of ties can vary depending upon the selection of the porous housing and the application of the device.

The porous housing can assume a number of different shapes and forms depending upon the application of the device. In one aspect, when the device is used to remove deicing salt ions from pavement and roadway deicing salt runoff, the porous housing can be a sock, sleeve, casing, or boom. The dimensions and size of the porous housing can vary depending upon the application and location where the device is to be used. In one aspect, the device is positioned in, on, or near a drain or at the mouth of a storm sewer. Depending upon the dimensions of the drain or the storm sewer, the dimension of the porous housing can be modified accordingly. In other embodiments two or more devices can be used. For example, two or more devices can be laid side-by-side to increase deicing salt ion removal as well as reduce the amount of water that enters a drainage system.

As demonstrated in the Examples, the devices described herein are effective in removing deicing salt ions from water. In one aspect, the amount of sodium ions removed from the water is from 5 grams to about 20 grams per 1 kilogram of the ionic binding material, or the amount is 5 grams, 6 grams, 7 grams, 8 grams, 9 grams, 10 grams, 11 grams, 12 grams, 13 grams, 14 grams, 15 grams, 16 grams, 17 grams, 18 grams, 19 grams, or 20 grams, where any value can be a lower and upper endpoint of a range (7 grams to 15 grams). In another aspect, the amount of chloride ions removed from the water is from 10 grams to about 30 grams per 1 kilogram of the ionic binding material, or the amount is 10 grams, 12 grams, 14 grams, 16 grams, 18 grams, 20 grams, 22 grams, 24 grams, 26 grams, 28 grams, or 30 grams, where any value can be a lower and upper endpoint of a range (12 grams to 24 grams). In another aspect, when the ionic binding material is biochar, the amount of sodium ions removed from the water is from 5 grams to about 20 grams per 1 kilogram of biochar and the amount of chloride ions removed from the water is from 10 grams to about 30 grams per 1 kilogram of biochar.

In addition to removing deicing salt ions from road runoff, the devices herein can reduce or prevent the flow of saline water into drains or off paved areas. The devices described herein a permeable barrier that will slow down flow rates. In the absence of the device, the rate of unfiltered saline runoff could be very rapid during snow melt or rain events after deicing salts were applied. This could overwhelm an ecosystem's natural ability to cope with salt stress. In addition to removing deicing salt ions, the devices herein slow the flow of runoff water into drainage systems and environments surrounding paved areas such as, for example, parking lots. Ecosystems downstream from paved areas would be less affected by slower release rates of saline water than massive bulk flow if no device were in place. Reducing the flow of runoff into the environment is another aspect of using the devices in paved areas. Thus, the devices reduce salt concentrations and reduce the rate at which salt enters surrounding ecosystems to levels that put less stress on plants and animals. As discussed above, multiple devices can be laid side-by-side to reduce water flow entering a drainage system.

In certain aspects, the devices once exposed to water composed of deicing salt ions can be further treated to remove the ions from the device. For example, the device could be transported to a facility that reclaims the salts present in the device. The recaptured salts can be redistributed for future deicing applications, which will save highway agencies money while simultaneously lowering the amount of deicing salt exposure to the environment.

In one aspect, the bulk water can be removed from the device and salt water collected. Salt from this faction could be concentrated and recollected by evaporating the water and collecting the saline residue that remains. In another aspect, ions bonded to the ionic binding material can be eluted from the material with an ionic solution having a higher ionic strength or higher concentration when compared to the ions present on the ionic binding material creating another solution rich in salt. In one aspect, the high ionic strength solution can subsequently be washed or removed from the substrate electrostatically. The resulting ionic binding material can then be subsequently dried and re-used (i.e., introduced into a porous housing).

### Aspects

Aspect 1. A method for removing deicing salt ions in water, the method comprising contacting the water with deicing salt ions with a device comprising an ionic binding material present in a porous housing.
Aspect 2. The method of Aspect 1, wherein the ionic binding material comprises a zeolite, biochar, constructed clay beads, hemp powder, hemp fibers, diatomaceous earth, an ion-exchange resin, or any combination thereof.
Aspect 3. The method of Aspect 1, wherein the ionic binding material comprises biochar.
Aspect 4. The method of Aspect 1, wherein the ionic binding material comprises biochar in combination with hemp powder, hemp hurd, hemp bast fiber, or a combination thereof.
Aspect 5. The method of any one of Aspects 1-4, wherein the porous housing comprises a natural polymer or a synthetic polymer.
Aspect 6. The method of any one of Aspects 1-4, wherein the porous housing comprises polypropylene.
Aspect 7. The method of any one of Aspects 1-4, wherein the device further comprises an absorbent in the housing.
Aspect 8. The method of Aspect 7, wherein the absorbent comprises vermiculite, polypropylene, cellulose, or any combination thereof.
Aspect 9. The method of any one of Aspects 1-8, wherein the porous housing comprises a sock, sleeve, casing, or boom.
Aspect 10. The method of any one of Aspects 1-9, wherein the water comprises cations selected from the group consisting of sodium, calcium, potassium, magnesium, and any combination thereof and chloride ions.
Aspect 11. The method of any one of Aspects 1-10, wherein when the ionic binding material is biochar, the amount of sodium ions removed from the water is from 5 grams to about 20 grams per 1 kilogram of biochar and the amount of chloride ions removed from the water is from 10 grams to about 30 grams per 1 kilogram of biochar.
Aspect 12. The method of any one of Aspects 1-11, wherein the water comprising the deicing salt ions comprises pavement and roadway deicing salt runoff.
Aspect 13. The method of any one of Aspects 1-12, wherein the device is positioned in, on, or near a drain or at the mouth of a storm sewer.
Aspect 14. A device comprising an ionic binding material present in a porous housing.
Aspect 15. The device of Aspect 14, wherein the ionic binding material comprises a zeolite, biochar, constructed clay beads, hemp powder or fibers, diatomaceous earth, an ion-exchange resin, or any combination thereof.
Aspect 16. The device of Aspect 14, wherein the ionic binding material comprises biochar.
Aspect 17. The device of Aspect 14, wherein the ionic binding material comprises biochar in combination with hemp powder, hemp hurd, hemp bast fiber, or a combination thereof.
Aspect 18. The device of any one of Aspects 14-17, wherein the porous housing comprises a natural polymer or a synthetic polymer.
Aspect 19 The device of any one of Aspects 14-17, wherein the porous housing comprises polypropylene.
Aspect 20. The device of any one of Aspects 14-17, wherein the device further comprises an absorbent in the housing.
Aspect 21. The device of Aspect 20, wherein the absorbent comprises vermiculite, polypropylene, cellulose, or any combination thereof.
Aspect 22. The device of any one of Aspects 14-21, wherein the porous housing comprises a sock, sleeve, casing, or boom.
Aspect 23. A method for recharging a device comprising an ionic binding material present in a porous housing, wherein the device comprises deicing salt ions, the method comprising removing the water with the ions from the device.
Aspect 24. The method of Aspect 23, wherein the device is further contacted with fresh water, an ionic solution, or a combination thereof to further remove the ions from the device.
Aspect 25. The method of Aspect 23 or 24, wherein the water with the ions is heated to isolate the deicing salt.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Examples

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure.

Materials and Methods

The materials used for this experiment were: a measuring bowl and cup, scale, scissors, a thermometer, zip ties, 5-gallon buckets, 3 plastic bins, 4 environmental containment socks, biochar, hemp hurd, and hemp fiber. Also, water was gathered from Slate Creek in Wilderville, Oregon. The environmental containment socks were supplied by New Pig Corp (Tipton, PA), which sells a wide variety of ECS designed to do a range of tasks like containing industrial spills and runoff from construction sites. The original material was removed, replaced with experimental biofilters, then resealed. The biochar was obtained from an amendment wholesaler in White City, OR; the biomass used to create the biochar was green waste in the form of tree cuttings from a nearby arborist. The hemp hurd was donated by Old Dominion Hemp, a Virginia-based distributor of high-quality hemp fibers for small animal bedding. The hemp bast fiber was sourced from Gordon Jones at the Southern Oregon Research and Extension Center, Central Point, OR.

A scale was used to weigh out treatments. Table 1 details the treatment and corresponding weight.

TABLE 1
Weights of Biofilter Sections for Control and Treatment Groups

| Treatment Number | Biofilter | Weight |
|---|---|---|
| 1A, 2A | Biochar | 585 g |
| 1B, 2B | Hemp Hurd | 250 g |
| 1C, 2C | Hemp Bast Fiber | 152 g |
| 1D, 2D | Biochar, Hemp Hurd, Hemp | 172 g |
| | Bast Fiber | 55 g |
| | | 55 g |

In preparation for the experiment, zip ties were used to divide the 4 ECS into 2 sections for 8 treatments. Biofilter materials were weighed and placed into a corresponding section of an ECS. For sections 1D and 2D, biochar, hemp hurd, and hemp fiber were mixed thoroughly then added. Of these 8 treatments, half would be placed into water without any NaCl added (control group) and the other half would be placed into a 100 mM solution of NaCl (treatment group); the treatment group was divided into 2 bins (sections 2A and 2B in 1 bin, sections 2C and 2D in the other). The untreated control group was included to show treatment differences and determine the extent of sodium chloride binding by the four treatments.

Samples were placed in a bin and soaked in the NaCl solution for 24 hours to ensure full hydration and complete binding and a weighted 5-gallon bucket was placed on top of the ECS to fully submerge them in the solution. A thermometer was placed in one of the bins to measure the temperature of the solution. After 24 hours, the ECS were removed from the bins and laid out to dry prior to shipping. The ECS and their contents were subsequently analyzed. Upon arrival, the ECS were still wet, so they were placed in a drier at 60° C. for 48 hours.

Treatments 1A and 2A were labeled as ‘combustion/thermal-by-products’ and given the waste code ‘CSO’ which means ‘ash, mixed or other’, whereas treatments 1B, 2B, 1C, 2C, 1D, and 2D were labeled as ‘non-composted raw materials’ and given the waste code ‘NCR’ which means crop residue. Prior to the analysis, a subsample (˜250 cm3) was weighed (Mettler PM4800; Mettler-Toledo, Hightstown, NJ), dried overnight (12-24 hr) at 80° C., reweighed, and ground with a stainless steel grinder (Intermediate Wiley Mill; Arthur H. Thomas Co.; Philadelphia, PA) to pass through a 20-mesh (1-mm) screen (adapted from Hoskins et al., 2003). Samples were wet-ashed using an open-vessel HNO3 microwave digestion system (MARS & MDS2100 microwaves; CEM Corp.; Matthews, NC) (Campbell and Plank, 1992). A 0.5-g, dried/ground aliquot of sample was digested in 10 mL 15.6N HNO3 for 5-30 minutes in a microwave, and then the prepared sample volume was brought to 50 mL with deionized water prior to measurement. After ashing, total Na⁺ concentration was determined with an inductively coupled plasma (ICP) spectrophotometer (Optima 3300 DV ICP emission spectrophotometer, Perkin Elmer Corporation; Shelton, CT) at 580.982 nm following Donohue and Aho (1992) and adapted from USEPA (2001). Total concentration of chloride was determined by the thiocyanate displacement method (Zall et al., 1956; Skalar Analytical 1995b) with an autoflow spectrophotometer analyzer (San++ Segmented Flow Auto-Analyzer, Skalar Instruments; Breda, The Netherlands) following a deionized water (1 g/25 mL), 30-minute extraction on a reciprocating shaker (Wrist Action Model 75; Burrell Corp. Pittsburgh, PA) (McGinnis et al., 2013).

Results & Discussion

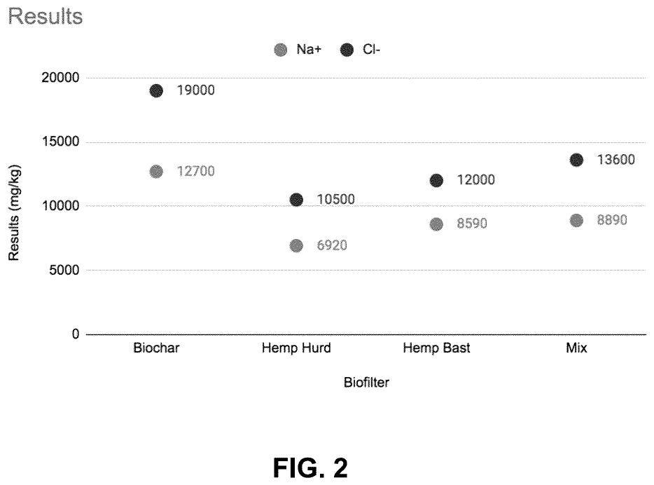

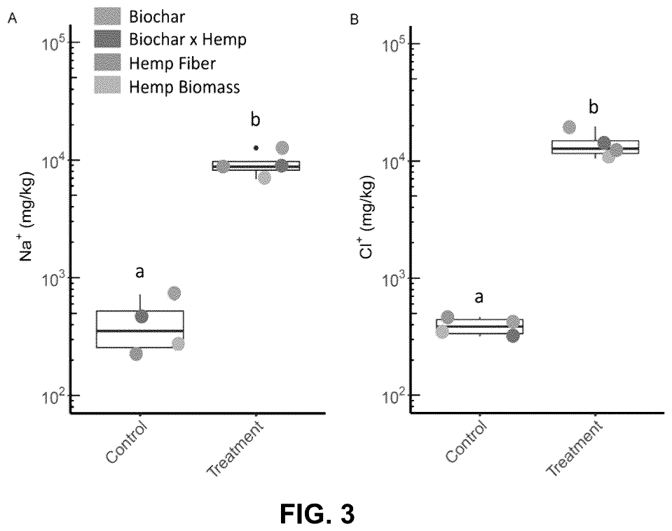

The most effective biofilter was biochar, followed by the mix, bast fiber, and finally hemp hurd (FIGS. 2 and 3). Biochar was the only biofilter that exceeded 10,000 mg Na⁺/kg and absorbed almost 20,000 mg Cl⁻/kg (FIG. 2). Na⁺ and Cl⁻ ions captured by biochar were 12,700 mg/kg and 19,800 mg/kg, respectively (FIG. 2). The mixture of biochar and hemp fibers was second in Na⁺ and Cl⁻ sequestration after the biochar-only section, with 8,890 mg/kg and 13,600 mg/kg, respectively (FIG. 2). Hemp bast fibers sequestered 8,590 mg Na⁺/kg and 12,000 mg Cl⁻/kg (FIG. 2). The hemp hurd biofilter absorbed the least Na⁺ (6,920 mg/kg) and Cl⁻ (10,500 mg/kg; FIG. 2). The relatively high adsorption capabilities of both hemp fibers are impressive as neither underwent any chemical modification or pyrolysis process.

Another way to state the results is by stating how much Na⁺ and Cl⁻ 1 kg of a given biofilter can bind to by weight. Binding capabilities of 1 kg of: biochar is 12.7 g Na⁺ and 19.8 g Cl⁻, hemp hurd is 6.92 g Na⁺ and 10.5 g Cl⁻, hemp bast 8.59 g Na⁺ and 12 g Cl⁻, mix is 8.89 g Na⁺ and 13.6 g Cl⁻. From this an estimation of how much road salt runoff an ECS can filter before it is theoretically saturated with Na⁺ and Cl⁻ ions can be determined assuming a 100 mM solution of NaCl. Sodium filtration capabilities of biochar, hemp hurd, hemp bast, and mix are 12.7, 6.92, 8.59, and 8.89 liters, respectively. Chloride filtration capabilities of biochar, hemp hurd, hemp bast, and mix are 19.8, 10.5, 12, 13.6 liters, respectively. Table 2 lists how many liters various biofilters could theoretically filter in novel applications of ECS in areas with NaCl runoff. Based on the literature, estimations of NaCl concentrations (mg/l) of runoff are used to approximate how many liters ECS could filter (Smith & Granato, 2010; Bennett & Linstedt, 1978; Fitch et al., 2005). Furthermore, because the full volume of ECS were divided to ensure there were enough sections for a control and treatment, an estimation of 10 kg of biofilter per ECS is assumed.

TABLE 2
Amount of NaCl runoff various 10 kg ECS could filter in liters. Multiple
concentrations of NaCl in runoff were listed based on literature
findings. Filtration values were calculated by averaging the amount of Na⁺
and Cl⁻ an ECS could filter based on analysis results.

| | NaCl | NaCl | NaCl | NaCl |
|---|---|---|---|---|
| Biofilter | 1,000 mg/l | 5,000 mg/l | 10,000 mg/l | 20,000 mg/l |
| Biochar Filtration | 323.8 | 64.8 | 32.4 | 16.2 |
| Hemp Hurd | 174 | 34.8 | 17.4 | 8.8 |
| Filtration | | | | |
| Hemp Bast | 207.4 | 41.5 | 20.8 | 10.4 |
| Filtration | | | | |
| Mix Filtration | 224.5 | 44.9 | 22.5 | 11.2 |

ECS containing biochar have the greatest potential to filter NaCl runoff. Assuming the lowest runoff concentrations of 1,000 mg/l NaCl, a 10 kg biochar ECS could filter 323.8 liters (˜85 gallons) before maximum binding capacity would be reached. In comparison, the highest concentration of 20,000 mg/l would require the same ECS to be replaced after 16.2 liters (˜4 gallons) of runoff.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

Abolfazli, E., & Strom, K. (2021). Deicing road salts may contribute to impairment of streambeds through alterations to sedimentation processes. ACS ES & T Water, 2(1), 148-155. https://doi.org/10.1021/acsestwater.1c00300
Ahmad, R., Tehsin, Z., Malik, S. T., Asad, S. A., Shahzad, M., Bilal, M., Shah, M. M., & Khan, S. A. (2015). Phytoremediation potential of hemp (Cannabis sativa L.): Identification and characterization of heavy metals responsive genes. CLEAN—Soil, Air, Water, 44(2), 195-201. https://doi.org/10.1002/clen.201500117
Alufasi, R.; Zeman, S.; Bagar, T.; Chingwaru, W. Cannabis sativa L. and its potential applications in environmental bioremediation. A review. Hmelj. Bilt. 2020, 27, 161-172.
Auge, R. M., Toler, H. D., & Saxton, A. M. (2014). Arbuscular mycorrhizal symbiosis and osmotic adjustment in response to NaCl Stress: A meta-analysis. Frontiers in Plant Science, 5. https://doi.org/10.3389/fpls.2014.00562
Awan, S., Ippolito, J. A., Ullman, J. L., Ansari, K., Cui, L., & Siyal, A. A. (2020). Biochars reduce irrigation water sodium adsorption ratio. Biochar, 3(1), 77-87. https://doi.org/10.1007/s42773-020-00073-z
Baltrėnas, P., Kazlauskienė, A., & Zaveckytė, J. (2006). Experimental investigation into toxic impact of road maintenance salt on grass vegetation. JOURNAL OF ENVIRONMENTAL ENGINEERING AND LANDSCAPE MANAGEMENT, 14(2), 83-88. https://doi.org/10.3846/16486897.2006.9636883
Bennett, E. R., & Linstedt, K. D. (1978). Pollutional characteristics of storm water runoff (Doctoral dissertation, Colorado State University. Libraries).
Betts, A. J., & Boulton, L. H. (1993). Crevice Corrosion: Review of mechanisms, modeling, and mitigation. British Corrosion Journal, 28(4), 279-296. https://doi.org/10.1179/000705993799156299
Bäckström, M., Karlsson, S., Bäckman, L., Folkeson, L., & Lind, B. (2004). Mobilisation of heavy metals by deicing salts in a roadside environment. Water Research, 38(3), 720-732. https://doi.org/10.1016/j.watres.2003.11.006
Casey, L. (2015, January). Farm awarded $100,000 for damage caused by road salt. The Canadian Press. Retrieved October 2022, from https://kitchenerctvnews.ca/mobile/farm-awarded-100-000-for-damage-caused-by-road-salt-1.2200177.
Chung, Y. G. 1981. Roadside Air Pollution. Chinook, Vol. 4, No. 1, pp. 4-5.
Cigasova, J., Stevulova, N., & Junak, J. (2014). Innovative use of biomass based on technical hemp in building industry. Chemical Engineering Transactions, 37.
Citterio, S., Santagostino, A., Fumagalli, P., Prato, N., Ranalli, P., & Sgorbati, S. (2003). Plant and Soil, 256(2), 243-252. https://doi.org/10.1023/a:1026113905129
Claros, B., Chitturi, M., Bill, A., & Noyce, D. A. (2022). Field performance of salt brine applications. Transportation Research Record: Journal of the Transportation Research Board, 036119812211141. https://doi.org/10.1177/03611981221114117
Dao, B., Hasanzadeh, S., Walker, C. L., Steinkruger, D., Esmaeili, B., & Anderson, M. R. (2019). Current practices of winter maintenance operations and perceptions of winter weather conditions. Journal of Cold Regions Engineering, 33(3). https://doi.org/10.1061/(asce)cr.1943-5495.0000191
Delhaize, E., & Ryan, P. R. (1995). Aluminum toxicity and tolerance in plants. Plant Physiology, 107(2), 315-321. https://doi.org/10.1104/pp. 107.2.315
Dewitz, J., 2019, National Land Cover Database (NLCD) 2016 Products (ver. 2.0, July 2020): U.S. Geological Survey data release, https://doi.org/10.5066/P96HHBIE.
Dindorf, C., Fortin, C., Asleson, B., & Erdmann, J. (2014). The Real Cost of Salt Use for Winter Maintenance in the Twin Cities Metropolitan Area. (Report No. wq-iw11-06bb). Fortin Consulting, Inc. https://www.pca.state.mn.us/sites/default/files/wq-iw11-06bb.pdf
D'Itri, F. M. (1992). Chemical Deicers and the environment. Lewis Publishers.
Duffin, K. (2021). Evaluation of the effectiveness of direct liquid application for reducing chloride inputs to Ryerson campus and urban areas in Toronto. https://doi.org/10.32920/ryerson.14667933.v1
Dugan, H. A., Bartlett, S. L., Burke, S. M., Doubek, J. P., Krivak-Tetley, F. E., Skaff, N. K., Summers, J. C., Farrell, K. J., McCullough, I. M., Morales-Williams, A. M., Roberts, D. C., Ouyang, Z., Scordo, F., Hanson, P. C., & Weathers, K. C. (2017). Salting our freshwater lakes. Proceedings of the National Academy of Sciences, 114(17), 4453-4458.
Eden, M. J., Bray, W., Herrera, L., & McEwan, C. (1984). terra preta soils and their archaeological context in the Caquetá Basin of southeast Colombia. American Antiquity, 49(1), 125-140. https://doi.org/10.2307/280517
Elvidge, C. D., Milesi, C., Dietz, J. B., Tuttle, B. T., Sutton, P. C., Nemani, R., & Vogelmann, J. E. (2004). U.S. constructed area approaches the size of Ohio. Eos, Transactions American Geophysical Union, 85(24), 233. https://doi.org/10.1029/2004eo240001
Environment Canada. (2001). Priority Substances List Assessment Report for Road Salts. https://www.canada.ca/en/health-canada/services/environmental-workplace-health/reports-publications/environmental-contaminants/canadian-environmental-protection-act-1999-priority-substances-list-assessment-report-road-salts.html
Evelin, H., Devi, T. S., Gupta, S., & Kapoor, R. (2019). Mitigation of salinity stress in plants by arbuscular mycorrhizal symbiosis: Current understanding and new challenges. Frontiers in Plant Science, 10. https://doi.org/10.3389/fpls.2019.00470
Feick, G., Horne, R. A., & Yeaple, D. (1972). Release of Mercury from contaminated freshwater sediments by the runoff of Road Deicing Salt. Science, 175(4026), 1142-1144. https://doi.org/10.1126/science.175.4026.1142
Fitch, G. M., Bartelt-Hunt, S., & Smith, J. A. (2005). Characterization and environmental management of storm water runoff from road salt storage facilities. Transportation Research Record: Journal of the Transportation Research Board, 1911(1), 125-132. https://doi.org/10.1177/0361198105191100112
Fitch, G. M., Craver, V. O., Smith, J. A., Virginia Transportation Research Council, Transportation, V. D. of, & Administration, U. S. F. H. (2008). Recycling of salt-contaminated stormwater runoff for brine production at Virginia Department of Transportation Road-salt storage facilities. Welcome to ROSA P. Retrieved Oct. 31, 2022, from https://rosap.ntl.bts.gov/view/dot/20103
Hintz, W. D., & Relyea, R. A. (2019). A review of the species, community, and ecosystem impacts of road salt salinisation in Fresh Waters. Freshwater Biology, 64(6), 1081-1097. https://doi.org/10.1111/fwb.13286
Holland, R. (2014, May). Estimating the Number of Parking Spaces Per Acre. University of Tennessee. https://www.south kingstown ri.com/DocumentCenter/View/5061/6—Parking-Guide-from-UT-compressed
Houk, E., Frasier, M., & Schuck, E. (2006). The agricultural impacts of irrigation induced waterlogging and soil salinity in the Arkansas Basin. Agricultural Water Management, 85(1-2), 175-183. https://doi.org/10.1016/j.agwat.2006.04.007
Houska, C. (2007). Deicing salt—recognizing the corrosion threat. International Molybdenum Association, Pittsburgh, TMR Consulting, 1-10.
Husain, R., Weeden, H., Bogush, D., Deguchi, M., Soliman, M., Potlakayala, S., Katam, R., Goldman, S., & Rudrabhatla, S. (2019). Enhanced tolerance of industrial hemp (Cannabis sativa L.) plants on abandoned mine land soil leads to overexpression of cannabinoids V1. https://doi.org/10.17504/protocols.io.4yxgxxn
Jackson, R. B., & Jobbágy, E. G. (2005). From icy roads to salty streams. Proceedings of the National Academy of Sciences, 102(41), 14487-14488. https://doi.org/10.1073/pnas.0507389102
Jones, B., Snodgrass, J. W., & Ownby, D. R. (2015). Relative toxicity of NaCl and road deicing salt to developing amphibians. Copeia, 103(1), 72-77. https://doi.org/10.1643/cp-13-082
Kamarudin, N. S., Dahalan, F. A., Hasan, M., An, O. S., Parmin, N. A., Ibrahim, N., Hamdzah, M., Zain, N. A. M., Muda, K., & Wikurendra, E. A. (2021). Biochar: A review of its history, characteristics, factors that influence its yield, methods of production, application in wastewater treatment and recent development. Biointerface Research in Applied Chemistry, 12(6), 7914-7926. https://doi.org/10.33263/briac126.79147926
Kaushal, S. S., Groffman, P. M., Likens, G. E., Belt, K. T., Stack, W. P., Kelly, V. R., Band, L. E., & Fisher, G. T. (2005). Increased salinization of fresh water in the Northeastern United States. Proceedings of the National Academy of Sciences, 102(38), 13517-13520. https://doi.org/10.1073/pnas.0506414102
Kearl, J., McNary, C., Lowman, J. S., Mei, C., Aanderud, Z. T., Smith, S. T., West, J., Colton, E., Hamson, M., & Nielsen, B. L. (2019). Salt-tolerant halophyte rhizosphere bacteria stimulate growth of alfalfa in salty soil. Frontiers in Microbiology, 10. https://doi.org/10.3389/fmicb.2019.01849
Kelly, V. R., Cunningham, M. A., Curri, N., Findlay, S. E., & Carroll, S. M. (2018). The distribution of road salt in private drinking water wells in a southeastern New York Suburban Township. Journal of Environmental Quality, 47(3), 445-451. https://doi.org/10.2134/jeq2017.03.0124
Kelly, W. R., Panno, S. V., & Hackley, K. C. (2012). Impacts of road salt runoff on water quality of the Chicago, Illinois, region. Environmental & Engineering Geoscience, 18(1), 65-81. https://doi.org/10.2113/gseegeosci.18.1.65
King, A., & Rattay, S. (2022, March 28). personal.
King, A., & Roller, A. (2022, March 31). personal.
Kotheimer, J. (1967). Physiological Factors In The Etiology And Alleviation Of Salt-Induced Decline Of Roadside Maples And Pines (dissertation).
Kumar, S., Singh, R., Kumar, V., Rani, A., & Jain, R. (2017). Cannabis sativa: A plant suitable for phytoremediation and Bioenergy Production. Phytoremediation Potential of Bioenergy Plants, 269-285. https://doi.org/10.1007/978-981-10-3084-0_10
Kushwaha, P., Kashyap, P. L., Bhardwaj, A. K., Kuppusamy, P., Srivastava, A. K., & Tiwari, R. K. (2020). Bacterial endophyte mediated plant tolerance to salinity: Growth responses and mechanisms of action. World Journal of Microbiology and Biotechnology, 36(2).
Laird, D. A. (2008). The charcoal vision: A win-win-win scenario for simultaneously producing bioenergy, permanently sequestering carbon, while improving soil and water quality. Agronomy Journal, 100(1), 178. https://doi.org/10.2134/agrojn12007.0161
Lakoba, V., Wind, L., DeVilbiss, S., Lofton, M., Bretz, K., Weinheimer, A., Moore, C., Baciocco, C., Hotchkiss, E., & Hession, W. C. (2020). Salt dilution and Flushing Dynamics of an impaired agricultural—urban stream. ACS ES&T Water, 1(2), 407-416. https://doi.org/10.1021/acsestwater.0c00160
Li, Y.-W., Tong, C.-L., & Sun, M.-F. (2022). Effects and molecular mechanism of mycorrhiza on the growth, nutrient absorption, quality of fresh leaves, and antioxidant system of tea seedlings suffering from salt stress. Agronomy, 12(9), 2163. https://doi.org/10.3390/agronomy12092163
Litalien, A., & Zeeb, B. (2020). Curing the Earth: A review of Anthropogenic Soil Salinization and plant-based strategies for sustainable mitigation. Science of The Total Environment, 698, 134235. https://doi.org/10.1016/j.scitotenv.2019.134235
Lowenfels, J. (2020). Chapter 4: The Nutrients. In Teaming with nutrients: The Organic Gardener's Guide to Optimizing Plant Nutrition (pp. 94-120). essay, Timber Press.
Löfgren, S. (2001). Water, Air, and Soil Pollution, 130(1/4), 863-868. https://doi.org/10.1023/a:1013895215558
Mahima, S., Moorthi, P. V., Bahurudeen, A., & Gopinath, A. (2018). Influence of chloride threshold value in service life prediction of reinforced concrete structures. Sādhanā, 43(7).
Makoi, J. H., & Verplancke, H. (2010). Effect of gypsum placement on the physical chemical properties of a saline sandy loam soil. Australian journal of crop science, 4(7), 556-563.
McConnell, H. H., & Lewis, J. (1972). . . . Add Salt to Taste. Environment: Science and Policy for Sustainable Development, 14(9), 38-44. https://doi.org/10.1080/00139157.1972.9930649
McGinnis, M., Queen, J., Buchanan, M., Stokes, C., & Cleveland, B. (2013). Waste and Compost Analysis Guide. N.C. Dept. of Agriculture & Consumer Services. https://www.ncagr.gov/agronomi/pdffiles/wasteguide.pdf
McNaboe, L. A., Robbins, G. A., & Dietz, M. E. (2017). Mobilization of radium and radon by deicing salt contamination of groundwater. Water, Air, & Soil Pollution, 228(3). https://doi.org/10.1007/s11270-016-3227-y
Mills, S. D., Mamo, M., Schacht, W. H., Abagandura, G. O., & Blanco-Canqui, H. (2020). Soil properties affected vegetation establishment and persistence on roadsides. Water, Air, & Soil Pollution, 231(12). https://doi.org/10.1007/s11270-020-04930-2
Munns, R., & Gilliham, M. (2015). Salinity tolerance of crops—what is the cost? New Phytologist, 208(3), 668-673. https://doi.org/10.1111/nph.13519
New Hampshire Department of Environmental Services. (2016). Road Salt and Water Quality [Fact Sheet]. https://www.des.nh.gov/sites/g/files/ehbemt341/files/documents/wmb-4.pdf
Nguyen, T.-T., Picandet, V., Amziane, S., & Baley, C. (2009). Influence of compactness and hemp Hurd characteristics on the mechanical properties of lime and hemp concrete. Revue Européenne De Génie Civil, 13(9), 1039-1050. https://doi.org/10.3166/ejece.13.1039-1050
Novotny, E. V., Sander, A. R., Mohseni, O., & Stefan, H. G. (2009). Chloride ion transport and mass balance in a metropolitan area using Road Salt. Water Resources Research, 45(12).
Ogawa, M., Okimori, Y., & Takahashi, F. (2006). Carbon sequestration by carbonization of biomass and forestation: Three case studies. Mitigation and Adaptation Strategies for Global Change, 11(2), 429-444. https://doi.org/10.1007/s11027-005-9007-4
Ohno, T. (1990). Levels of total cyanide and NaCl in surface waters adjacent to road salt storage facilities. Environmental Pollution, 67(2), 123-132. https://doi.org/10.1016/0269-7491(90)90077-p
Olivo, A. (2022, August 8). Salt in water sources becoming worrisome in D.C. region, experts warn. The Washington Post. Retrieved 2022, from https://www.washingtonpost.com/dc-md-va/2022/08/08/salt-sodium-water-levels-dc/.
Pieper, K. J., Tang, M., Jones, C. N., Weiss, S., Greene, A., Mohsin, H., Parks, J., & Edwards, M. A. (2018). Impact of road salt on drinking water quality and infrastructure corrosion in private wells. Environmental Science & Technology, 52(24), 14078-14087. https://doi.org/10.1021/acs.est.8b04709
Popoola, A., Olorunniwo, O. E., & Ige, O. O. (2014). Corrosion resistance through the application of anti-corrosion coatings. Developments in Corrosion Protection.
Qadir, M., Quillérou, E., Nangia, V., Murtaza, G., Singh, M., Thomas, R. J., Drechsel, P., & Noble, A. D. (2014). Economics of salt-induced land degradation and restoration. Natural Resources Forum, 38(4), 282-295. https://doi.org/10.1111/1477-8947.12054
Reeves, R. D., Baker, A. J., Jaffré, T., Erskine, P. D., Echevarria, G., & Ent, A. (2017). A global database for plants that hyperaccumulate metal and metalloid trace elements. New Phytologist, 218(2), 407-411. https://doi.org/10.1111/nph.14907
Reh, R., & Barbu, M. C. (2017). Hemp. In Performance of bio-based Building Materials (pp. 105-112). essay, Woodhead Publishing.
Renshaw, A. J. (2021). (rep.). Mitigating Pollution from Runoff of Roadway Deicing Salts in Virginia: A Review of Candidate Halophytes, Halophilic Microbes, and Soil Amendments for Future Remediation Efforts. Retrieved May 2022, from http://hdl.handle.net/10919/107131.
Rippy, M. A., Welbaum, G. E., Alden, A., Galanopoulos, C., Renshaw, A., Long, S., Krauss, L., King, A., & Fausey, K. (2022). (rep.). FIELD TESTING THE EFFECTIVENESS OF USING HALOPHYTES GROWING IN BIOCHAR-AMENDED SOIL TO CAPTURE AND REMOVE SALT FROM HIGHWAY AND PARKING LOT STORMWATER RUNOFF. Special Report to the Virginia Department of Environmental Quality for the Legislature of the Commonwealth of Virginia.
Siegel, L. (2007). Hazard identification for human and ecological effects of sodium chloride road salt.
Smith, K. P., & Granato, G. E. (2010). Quality of stormwater runoff discharged from Massachusetts Highways, 2005-07. Scientific Investigations Report. https://doi.org/10.3133/sir20095269
Stevulova, N., Cigasova, J., Estokova, A., Terpakova, E., Geffert, A., Kacik, F., Singovszka, E., & Holub, M. (2014). Properties characterization of chemically modified hemp hurds. Materials, 7(12), 8131-8150. https://doi.org/10.3390/ma7128131
Stevulova, N., Cigasova, J., Purcz, P., Schwarzova, I., Kacik, F., & Geffert, A. (2015). Water absorption behavior of hemp hurds composites. Materials, 8(5), 2243-2257. https://doi.org/10.3390/ma8052243
Stranko, S., Bourquin, R., Zimmerman, J., Kashiwagi, M. T., McGinty, M., & Klauda, R. J. (2013). Do road salts cause environmental impacts?. Monitoring and Non-Tidal Assessment Division, Resource Assessment Service, Maryland Department of Natural Resources.
Tan, Z., Lin, C. S. K., Ji, X., & Rainey, T. J. (2017). Returning biochar to fields: A Review. Applied Soil Ecology, 116, 1-11. https://doi.org/10.1016/j.apsoil.2017.03.017
Tiwari, A., & Rachlin, J. W. (2018). A review of Road Salt Ecological Impacts. Northeastern Naturalist, 25(1), 123-142. https://doi.org/10.1656/045.025.0110
Toler, L. G., & Pollock, S. J. (1974). Retention of chloride in the unsaturated zone. J. Res. US Geol: Surv, 2(1), 119-123.
U.S. Geological Survey (2022). Mineral Commodity Summaries 2022—Salt. https://pubs.usgs.gov/periodicals/mcs2022/mcs2022-salt.pdf
U.S. Geological Survey. (n.d.). Rainfall calculator. How much water falls during a storm? Rainfall calculator (English units) How much water falls during a storm? USGS Water Science School. Retrieved Dec. 3, 2022, from https://water.usgs.gov/edu/activity-howmuchrain.html
USEPA. (2022). Winter is Coming! And with it, tons of salt on our roads. https://www.epa.gov/sites/default/files/2021-03/documents/winter-coming-tons-salt.pdf
USEPA. (2022, Aug. 31). Overview of Total Maximum Daily Loads (TMDLs). EPA. Retrieved Sep. 1, 2022, from https://www.epa.gov/tmdl/overview-total-maximum-daily-loads-tmdls #:˜:text=approved %20by%20EPA%3F,What %20 isc)/020e/020TMDL %3F,standard%20for%20that%20particular%20pollutant.
USEPA. 2003. Drinking Water Advisory: Consumer Acceptability Advice and Health Effects Analysis on Sodium. EPA 822-R-03-006.
Valleau, R. E., Rühland, K. M., Paterson, A. M., & Smol, J. P. (2022). Using diatoms to track road-salt seepage into small, shallow, softwater ontario lakes. Canadian Journal of Fisheries and Aquatic Sciences, 79(9), 1514-1528. https://doi.org/10.1139/cjfas-2021-0072
Varga, I., Iljkić, D., Tkalec Kojić, M., Dobreva, T., Markulj Kulundžić, A., & Antunović, M. (2022). Germination of Industrial Hemp (Cannabis sativa L.) at Different Level of Sodium Chloride and Temperatures. Agriculturae Conspectus Scientificus, 87(1), 11-15.
Virginia Department of Transportation. (2021). VDOT Equipment and Supplies 2021-2022 Winter Season [Fact Sheet]. https://www.virginiadot.org/travel/resources/snow/FactSheets/21148_snowFactSHEET-1_acc111721.pdf
Vitaliano, D. F. (1992). An economic assessment of the social costs of highway salting and the efficiency of substituting a new deicing material. Journal of Policy Analysis and Management, 11(3), 397. https://doi.org/10.2307/3325069
Vávrová, K., Solcova, O., Knápek, J., Weger, J., Soukup, K., Humešová, T., Králik, T., & Bim, J. (2022). Economic evaluation of hemp's (Cannabis sativa) residual biomass for production of direct energy or biochar. Fuel, 329, 125435. https://doi.org/10.1016/j.fuel.2022.125435
Wickham, J., Herold, N., Stehman, S. V., Homer, C. G., Xian, G., & Claggett, P. (2018). Accuracy assessment of NLCD 2011 impervious cover data for the Chesapeake Bay Region, USA. ISPRS Journal of Photogrammetry and Remote Sensing, 146, 151-160. https://doi.org/10.1016/j.isprsjprs.2018.09.010
Wickham, J., Stehman, S. V., Neale, A. C., & Mehaffey, M. (2020). Accuracy assessment of NLCD 2011 percent impervious cover for selected USA metropolitan areas. International Journal of Applied Earth Observation and Geoinformation, 84, 101955. https://doi.org/10.1016/j.jag.2019.101955
Willmert, H. M., Osso, J. D., Twiss, M. R., & Langen, T. A. (2018). Winter Road management effects on roadside soil and vegetation along a mountain pass in the Adirondack Park, New York, USA. Journal of Environmental Management, 225, 215-223. https://doi.org/10.1016/j.jenvman.2018.07.085
Xian, G., Shi, H., Dewitz, J., & Wu, Z. (2019). Performances of worldview 3, Sentinel 2, and Landsat 8 data in mapping impervious surface. Remote Sensing Applications: Society and Environment, 15, 100246. https://doi.org/10.1016/j.rsase.2019.100246
Yang, R., Liu, G., Xu, X., Li, M., Zhang, J., & Hao, X. (2011). Surface texture, chemistry and adsorption properties of Acid Blue 9 of hemp (Cannabis sativa L.) bast-based activated carbon fibers prepared by phosphoric acid activation. Biomass and Bioenergy, 35(1), 437-445. https://doi.org/10.1016/j.biombioe.2010.08.061
Zhao, J. J., Shen, X.-J., Domene, X., Alcañiz, J.-M., Liao, X., & Palet, C. (2019). Comparison of biochars derived from different types of feedstock and their potential for heavy metal removal in multiple-metal solutions. Scientific Reports, 9(1).
Luczak, K., Czerniawska-Kusza, I., Rosik-Dulewska, C., & Kusza, G. (2021). Effect of nacl road salt on the Ionic composition of soils and Aesculus hippocastanum l. foliage and leaf damage intensity. Scientific Reports, 11(1). https://doi.org/10.1038/s41598-021-84541-x

1. A method for removing deicing salt ions in water, the method comprising contacting the water with deicing salt ions with a device comprising an ionic binding material present in a porous housing.

2. The method of claim 1, wherein the ionic binding material comprises a zeolite, biochar, constructed clay beads, hemp powder, hemp fibers, diatomaceous earth, an ion-exchange resin, or any combination thereof.

3. The method of claim 1, wherein the ionic binding material comprises biochar alone or in combination with hemp powder, hemp hurd, hemp bast fiber, or a combination thereof.

4. The method of claim 1, wherein the porous housing comprises polypropylene.

5. The method of claim 1, wherein the device further comprises an absorbent in the housing.

6. The method of claim 5, wherein the absorbent comprises vermiculite, polypropylene, cellulose, or any combination thereof.

7. The method of claim 1, wherein the porous housing comprises a sock, sleeve, casing, or boom.

8. The method of claim 1, wherein the water comprises cations selected from the group consisting of sodium, calcium, potassium, magnesium, and any combination thereof and chloride ions.

9. The method of claim 1, wherein when the ionic binding material is biochar, the amount of sodium ions removed from the water is from 5 grams to about 20 grams per 1 kilogram of biochar and the amount of chloride ions removed from the water is from 10 grams to about 30 grams per 1 kilogram of biochar.

10. The method of claim 1, wherein the water comprising the deicing salt ions comprises pavement and roadway deicing salt runoff.

11. The method of claim 1, wherein the device is positioned in, on, or near a drain or at the mouth of a storm sewer.

12. A device comprising an ionic binding material present in a porous housing.

13. The device of claim 12, wherein the ionic binding material comprises a zeolite, biochar, constructed clay beads, hemp powder or fibers, diatomaceous earth, an ion-exchange resin, or any combination thereof.

14. The device of claim 12, wherein the ionic binding material comprises biochar alone or in combination with hemp powder, hemp hurd, hemp bast fiber, or a combination thereof.

15. The device of claim 12, wherein the porous housing comprises polypropylene.

16. The device of claim 12, wherein the device further comprises an absorbent in the housing.

17. The device of claim 14, wherein the absorbent comprises vermiculite, polypropylene, cellulose, or any combination thereof.

18. The device of claim 12, wherein the porous housing comprises a sock, sleeve, casing, or boom.

19. A method for recharging a device comprising an ionic binding material present in a porous housing, wherein the device comprises deicing salt ions, the method comprising removing the water with the ions from the device.

20. The method of claim 19, wherein the device is further contacted with fresh water, an ionic solution, or a combination thereof to further remove the ions from the device.
